(19) United States
(12) Patent Application Publication
(10) Pub. No.: US 2005/0250562 A1
(43) Pub. Date: Nov. 10, 2005

(54) Hand-held, mobile personal computing device/phone

(76) Inventor: David Carroll, Green Valley, AZ (US)

Correspondence Address: DICKE, BILLIG & CZAJA, P.L.L.C., FIFTH STREET TOWERS, 100 SOUTH FIFTH STREET, SUITE 2250, MINNEAPOLIS, MN, 55402, US

(21) Appl. No.: 11/111,635

(22) Filed: Apr. 21, 2005

Related U.S. Application Data
(60) Provisional application No. 60/563,937, filed on Apr. 21, 2004.
(60) Provisional application No. 60/564,631, filed on Apr. 21, 2004.

(51) Int. Cl. H04Q 7/20

(52) U.S. Cl. 455/575.3; 455/556.1

(57) ABSTRACT

A hand-held, mobile personal computing device including a cover and a base including a cover housing, a microphone, and a speaker. The microphone is supported by the cover housing, as is the speaker. The base includes a base housing, a display, and a microprocessor. The display is supported by the base housing and is in an electronic communication with the display. The microprocessor is adapted to perform mobile telephone operations. The cover housing is removably attached to the base housing to provide an attached state and a detached state. The microphone and speaker are communicatively linked to the microprocessor in both the attached and detached states, such that the cover is operable by a user as a telephone in either state.

### CROSS-REFERENCE TO RELATED APPLICATIONS

The subject matter of this application is related to the subject matter of U.S. Provisional Patent Application Ser. No. 60/563,937, filed Apr. 21, 2004 and entitled “Mobile Computing Devices” (Attorney Docket No. P374.102.101) and U.S. Provisional Patent Application Ser. No. 60/564,631, filed Apr. 21, 2004 and entitled “Mobile Computing Devices” (Attorney Docket No. P374.103.101), priority to which is claimed under 35 U.S.C. §119(e) and an entirety of both of which are incorporated herein by reference.

### BACKGROUND

The present invention relates to hand-held, mobile computing devices. More particularly, it relates to a hand-held, mobile computing device capable of performing telephone operations.

Mobile or cellular telephones are virtually commonplace in today's society. Continued advancement in the technology and manufacturing of various components associated with mobile phones (e.g., processor, memory, display, etc.) has greatly enhanced the operational capabilities of such devices. A highly desired advancement has been a drastic reduction in an overall size of the phone. Similarly, the format of personal computers has continued to evolve, such that efforts have been made to develop a highly portable, personal computing device sized to be held and operated with only the user's hand(s). These efforts, in turn, have resulted in the possibility of providing a hand-held, mobile personal computing device capable of functioning as a mobile phone in addition to performing other computing operations. In doing so, however, an overall size of the mobile phone/computing device housing will inherently be increased, in direct contrast to consumer preferences for mobile phones. That is to say, currently available and contemplated combination mobile phone/computing devices may not be met with complete consumer enthusiasm due to their enlarged size as compared to current mobile phones.

Therefore, a need exists for an improved, hand-held, mobile personal computing device capable of functioning as a mobile telephone.

### SUMMARY

One aspect of the present invention relates to a hand-held, mobile personal computing device including a cover and a base. The cover includes a cover housing, a microphone, and a speaker. The microphone is supported by the cover housing, as is the speaker. The base includes a base housing, a display, and a microprocessor. The display is supported by the base housing and is in electronic communication with the display. Further, the microprocessor is adapted to facilitate performance of mobile telephone operations (such as by coordinating operations of a transceiver). With this in mind, the cover housing is removably attached to the base housing to provide an attached state and a detached state. In the attached state, the cover housing covers at least a portion of the display, whereas in the detached state, the display is fully exposed. Further, the microphone and speaker are communicatively linked to the microprocessor in both the attached and detached states, such that the cover is operable by a user as a telephone in either state. More particularly, audio input received at the microphone is transmitted to the microprocessor for subsequent processing as part of a telephone operation. Thus, the cover operates to and through the base. In another embodiment, the cover and base establish a wired connection in the attached state.

Another aspect of the present invention relates to a method of operating a hand-held mobile computing device. The method includes removing a cover of the device from the base of the device, such that a display associated with the base is exposed. A mobile phone operational mode is initiated. Audio input is received at a microphone associated with the cover. An audio input signal is wirelessly transmitted from a microphone to a microprocessor associated with the base based upon the received audio input. The microprocessor is operated to direct performance of a mobile telephone transmission from the base based upon the audio input signal. The microprocessor is also operated to direct reception and processing of incoming audio information. This incoming audio information is wirelessly transmitted as a signal from the base to the speaker. The speaker then delivers an audio output based upon the received signal. Finally, the cover is returned to the base to at least partially cover the display.

### BRIEF DESCRIPTION OF THE DRAWINGS

FIG. 1 is a perspective view of a hand-held, mobile computing device in accordance with the present invention in an opened position;

FIG. 2 is a side view of the device of FIG. 1 in a closed position;

FIG. 3 is a front view of the device of FIG. 1 in the closed position;

FIG. 4 is a perspective view of a base portion of the device of FIG. 1;

FIG. 5 is a side view of the base of FIG. 4; and

FIG. 6 is a front view of the base of FIG. 4.

### DETAILED DESCRIPTION

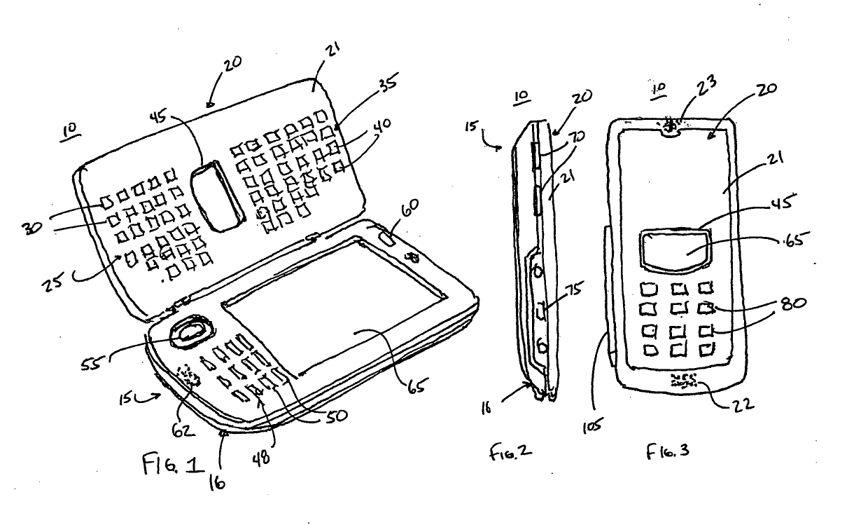

As shown in e.g. FIGS. 1-6, tablet-type computer or other electronic computing or processing device 10 includes base 15 and cover 20. Cover 20 is, in one embodiment, hinged to base 15 such that cover 20 pivots from an opened position, shown in e.g. FIG. 1, to a closed position, shown in e.g. FIG. 3. Cover 20 includes cover housing 21, microphone 22, speaker 23, and a transceiver (not shown). In one embodiment, cover 20 further includes left hand key set or keypad 25 comprising multiple keys 30, and right hand key set or keypad 35 comprising multiple keys 40. Cover 20 also includes opening or aperture 45 in and through cover housing 21.

Base 15 includes base housing 16, microprocessor (not shown) electronically connected to a transceiver (not shown), key set or keypad 48 comprising keys 50, and further includes function button 55, slider switch or other function button 60, microphone 62 optionally associated with microphone 22 in cover 20, and display 65. Additional function buttons 70, port 75 and other optional function or docking features are disposed on a side or edge of device 10, as shown in e.g. FIG. 2.

In one embodiment, the transceiver associated with cover 20 is a short range transceiver (thus requiring less power, such as Bluetooth), whereas the transceiver associated with base 15 is a longer range transceiver, capable of performing mobile telephone operations (as coordinated by the microprocessor of base 15). Regardless, the transceivers are both wireless such that device 10 is operable with cover 20 detached from base 15, and a wireless connection is maintained there between such that the microprocessor of base 15 can facilitate audio activities, to and from cover 20 (with cover 20 removed from base), of local and long distance transmission networks. Where cover 20 includes a short range transceiver, it will be understood that cover 20, though detached from base 15, should be within close proximity to base 15 (e.g., within 30 feet).

FIG. 3, showing device 10 in a closed configuration, illustrates opening 45 displaying a portion of display 65, and a plurality of keys or buttons 80 with numeric indicia e.g. in the form of a partial or complete telephone keypad. FIG. 3 also illustrates speaker 23 and microphone 22. In this configuration, device 10 is usable in the manner of a mobile (i.e., cellular) telephone or other wireless communication device. More particularly, microphone 22 and speaker 23 are in electronic communication with microprocessor (not shown) provided with base 15, such that base 15 facilitates operation of cover 20 as a mobile phone when separated from base 15.

Device 10 is sized to be easily held in a hand 90 of a user. In an opened position of FIG. 1, thumbs of the user easily and intuitively manipulating keys 30, 40 of key sets 25, 35.

According to embodiments of the invention, cover 20 is readily removable from base 15. Cover 20 snaps or slides in to base 15, according to one embodiment, and/or slides, snaps or otherwise moves into a supporting relationship with a hinge formed on or in base 15, for example. In the attached state (whereby cover housing 21 is attached to base housing 16) or the detached state (whereby cover housing 21 is removed from base housing 16), microphone 22 and speaker 23 of cover 20 remain communicatively linked to microprocessor of base 15. In one embodiment, cover 20 and base 15 include corresponding electrical connectors (e.g., cover 20 includes a USB connector) such that in the attached state, the corresponding electrical connectors connect, establishing a wired connection between cover 20 and base 15 (e.g., microphone 22 and speaker 23 have a wired connection with the microprocessor provided with base 15). In another embodiment, device 10 is adapted such that in the attached state, a connector established by and between cover housing 21 and base housing 16 is a dual feature connection, providing a hinged relationship between housings 16, 21, as well as an electronic connection between cover 20 and base 15 (and in particular microprocessor associated with base 15).

In the detached state, for example, a local LAN (e.g., bluetooth) connection is maintained between cover 20 and base 15 in the detached state, allowing a user to use cover 20 as a mobile phone. In another embodiment, speaker 23 can be removed from a remainder of cover 20 (e.g., where speaker 23 is provided as part of an earbud) such that cover housing 21 need not necessarily be removed from base housing 16 during a telephone operation. Microphone 22 can be similarly removably assembled to cover housing 21.

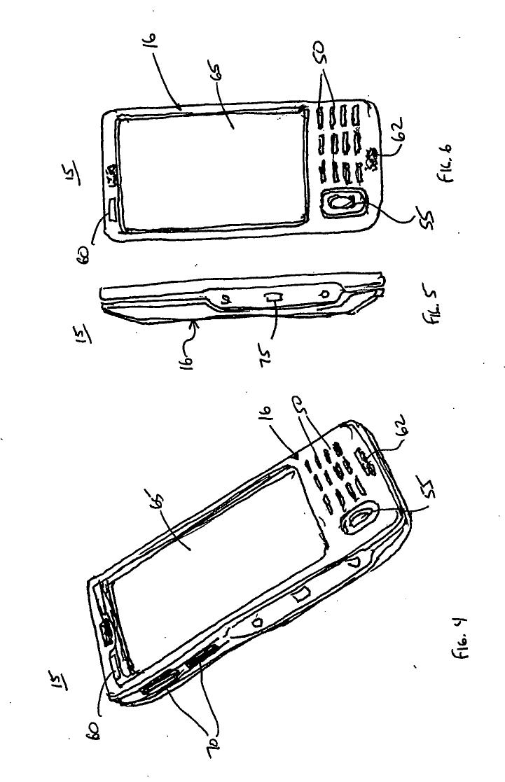

FIGS. 4-6 illustrate base 15 with cover 20 removed. Whether or not cover 20 is attached, base 15 functions as a fully operational personal computer, personal digital assistant (PDA) or other computing device, for example. A user of the device manipulates display 65 with a stylus or other utensil, by touch, by voice, or in another manner.

Device 10 thus is a mobile PC device with thumb-operated keypads 25, 35 disposed above display 65 on hinged display cover 20. When cover 20 is raised, keypads 25, 35 on cover 20 and keypad 45 on base 15 are exposed. Cover 20 optionally includes an integrated pointing device for use with display 65 as a touch screen. A stylus also is optionally provided for input to device 10 via display 65, and one embodiment of stylus and its placement is illustrated at 105 between cover 20 and base 15. A stylus also is shown in e.g. FIG. 3.

Cover 20 and/or keypads 25, 35 optionally are constructed of clear materials having translucent control markings or key labels, and/or glowing control markings that may be correctly read from the inside of device 10, e.g. when cover 20 is open, and/or from the outside of device 10, e.g. when cover 20 is closed, using light from display 65 or another source. Cover 20 optionally is constructed with geared edges to aid opening and closing with respect to base 15. Electronics, connectors for docking functions, power-in and various I/O capabilities are provided as shown in e.g. the side view of FIG. 2.

Sensors according to embodiments of the invention detect whether cover 20 is open or closed with respect to base 15. Opening and closing cover 20 optionally controls computer on-off and/or sleep-wake functions. When cover 20 is closed, only that portion of display 65 exposed through opening 45 in cover 20 is activated, e.g. in the manner of a cellular telephone with text-messaging or other text/display capabilities. Additionally, the remainder of display 65 optionally is used to simultaneously display other information related to use of device 10 as a cellular telephone, e.g. call log information, messages, missed calls, and other information. Additionally, or alternatively, a portion of display 65 distinct from that portion exposed through opening 45 is used to display cellular-telephone information, PC/PDA output, or other information even while device 10 is being used as a phone.

When cover 20 is removed from base 15, input to base 15, functioning as a fully operable PC/PDA or the like, occurs by e.g. voice, touch screen, keypad 45, or other input modes, as previously described. According to one embodiment, device 10 optionally switches to a primary voice-input functionality when keyboard/cover 20 is removed. Additionally, or alternatively, wireless communication occurs between cover 20 and base 15 such that keypads 25, 35 still can be used for input to base 15, even when cover 20 is removed. According to another embodiment, cover 20 includes a standard or modified QWERTY keyboard or other desired keyboard arrangement.

According to a method of use, a user removes cover 20 from base 15, placing speaker 23 near the user's ear and microphone 22 near the user's mouth. Unlike available mobile phone systems in which a necklace-type microphone is placed around the user's neck, cover 20 positions wirelessly connected microphone 22 in an appropriate position relative to the user's mouth when naturally held by the user. Thus, cover 20 provides not only an enhanced mobile phone operations, but can also provide appropriate input for use of device 10 to perform, for example, speech recognition operations. Regardless, a wireless connection maintained between microprocessor (not shown) associated with base 15 and microphone 22 and speaker 23 allows the user to perform a mobile telephone operation via a wireless link. In addition, cover 20 can be operated by a user in a similar fashion as an input device to base 15 (and in particular, the microprocessor) to control computing operations being performed by base 15. That is to say, microphone 22 provides wireless input to base 15 for controlling computing operations performed by the microprocessor.

In an alternative method of the present invention, a user holds device 10 in his or her hand and operates device 10 as a mobile telephone, viewing that portion of display 65 visible through opening 45 and manipulating keys 80 as desired. Buttons 70 optionally are used as call/end buttons, or other buttons or input devices optionally are provided on or in association with cover 20. Additionally, that portion of display 65 available for viewing through aperture 45 is provided with touch pad and/or stylus-input capabilities suitable for use with a cellular phone. A method of operation further includes opening cover 20 with respect to base 15 and operating device 10 as a PC, PDA, or other mobile computing device, using keypad 45, button/slider 55, 60, microphone 62 for e.g. voice input, touch pad or stylus-activated display 65, or other input devices or methods. The user receives output by audio e.g. through speaker 64 and/or 23, display 65, or e.g. by a separate monitor or other output device wirelessly or hard-wire connected to device 10 e.g. via a suitable port.

Embodiments of the invention further comprise multiple displays, e.g. an additional remote display in addition to display 65 wirelessly or hard-wired to base 15, micro display formats, small-screen zooming based on distance sensed to a user's head or body, two-way language translation features, micro/macro display drivers, thumb-over-display keyboard features as illustrated in the figures, for example, and other features. Embodiments of the invention provide an ultra-mobile touch tablet of generally pocket width and thickness.

According to embodiments of the invention, a single flat-panel display 65 includes automated zooming using distance sensors. In this system, a flat-panel image is automatically zoomed larger or smaller. A user controls on/off functioning of the zoom features, e.g. by enabling or disabling the distance sensors. The sensors are disposed in or on base 15 or cover 20 for measuring distance to the body, head or face of the user, to establish magnification of the screen as it is moved closer to or farther from the user. Zooming is used to accomplish adequate view of standard documents on a much smaller display than is available e.g. with a desktop device.

According to one example of use, a user sets a standard full-view at 1.5 feet between the sensor and the face. By moving device 10 (and associated sensor(s)) closer to or farther from the face or head, the display automatically grows or shrinks image magnification at a user-determined rate for the purpose of easier viewing/reading. Sensor/zoom activation/deactivation is by a dedicated or other button, e.g. button/slider 55, 60 which, when released, freezes zooming at a desired level. If the user taps or otherwise activates the button twice, for example, the image reverts to the original standard full window. Zoom control is rapid, fast and one-handed. Pan and tilt control optionally is implemented using a similar system, with one or more orientation sensors, e.g., camera, accelerometers, strain gauges, potentiometers, or other orientation sensors. All or portion(s) of display 65 optionally are affected. Brightness, contrast, and other display features also optionally are adjusted based on distance between device 10 and the user's head, face, body, etc. as determined by the sensors.

According to other embodiments, a series of multiple sensors (e.g., cameras) is disposed e.g. behind or adjacent display 65 for sensing a user's finger or hand. By waving the hand in front of the sensors at a certain rate and/or in a certain direction, different instructional commands are communicated to base 15. For example, features or functions are activated or de-activated, device 10 is put to sleep, turned on, or turned off, based on hand movement, finger movement, or body movement. For example, waving in one direction is used to zoom in, and waving in the opposite direction is used to zoom out, i.e. to provide different magnification levels for display 65. Moving the hand toward one portion of display 65 or another optionally moves or selects a portion of a larger virtual screen for display, in the manner of steering around a larger display that is too big to be shown on display 65. Waving the hand also or alternatively optionally is used to adjust volume level, advance to a subsequent or previous song, document, photograph, or other feature.

Certain specific embodiments of the invention have been described herein. Those of ordinary skill in the art will appreciate that additional embodiments and features are contemplated according to embodiments of the invention. Device 10 according to embodiments of the invention is, or is useable as, a PC, PDA, cellular telephone or other wireless communications device, a camera, and a number of other electronic devices.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A hand-held, mobile personal computing device comprising:
a cover including:
a cover housing,
a microphone supported by the cover housing,
a speaker supported by the cover housing; and
a base including:
a base housing,
a display supported by the base housing,
a microprocessor in electronic communication with the display, the microprocessor adapted to facilitate performance of mobile telephone operations and computing operations;
wherein the cover housing is removably attached to the base housing to provide an attached state and a detached state, the cover housing covering at least a portion of the display in the attached state, and the display being exposed in the detached state;
and further wherein the microphone and the speaker are communicatively linked to the microprocessor in the attached and detached state such that the cover is operable by a user as a phone in the attached and detached states, whereby audio input received at the microphone is transmitted to the microprocessor for subsequent processing as part of a telephone operation.

2. The device of claim 1, wherein the device is configured such that in the detached state, the microphone and speaker wirelessly communicate with the microprocessor.

3. The device of claim 1, wherein the microprocessor is adapted to perform computing operations including prompting display of desired content on the display, and further wherein the device is configured such that in the detached state, the microphone provides an audio input to the microprocessor for controlling the performed computing operations.

4. The device of claim 1, wherein at least one of the microphone and speaker are removable from the cover housing.

5. The device of claim 1, wherein the cover and the base each further include mating connector elements extending from the cover housing and the base housing, respectively, the connector elements configured to establish a hinged connection between the cover housing and the base housing, and an electrical communication link of the speaker and the microphone with the microprocessor.

6. The device of claim 1, wherein the cover housing defines a front side and a back side, the back side being adjacent the display and the back side being opposite the display in an attached, closed position, the device further comprising:
a keypad supported by the cover housing and communicatively linked to the microprocessor in both the attached and detached states such that the keypad serves as a user input for controlling computing operations performed by the microprocessor.

7. The device of claim 6, wherein in the attached state, the cover housing is transitionable from a closed position in which the display is at least partially covered and an opened position in which the display is fully exposed, and further wherein the device is configured such that in the opened position, the base housing is held in a user's hand and the keypad is positioned for activation by the user's thumb.

8. The device of claim 7, wherein the cover further includes a second keypad supported by the cover housing, the device configured such that in the opened position, the second keypad is positioned for activation by a second thumb of the user when the base housing is held in the user's hands.

9. The device of claim 1, wherein the cover housing forms an aperture, the device being configured such that in the attached state, a portion of the display is viewable through the aperture.

10. The device of claim 9, wherein the microprocessor is further adapted to activate only that portion of the display corresponding with the aperture when the cover housing is in a closed position relative to the base housing.

11. The device of claim 1, wherein the base further includes a second microphone carried by the base housing, the microprocessor being further adapted to perform a language translation operation based upon audio inputs received at the first and second microphones.

12. The device of claim 1, wherein the device is configured to perform a speech recognition operation in the detached state.

13. A method of operating a hand-held, mobile computing device, the method comprising:
removing a cover of the device from a base of the device such that a display associated with the base is exposed;
initiating a mobile phone operational mode;
receiving an audio input at a microphone associated with the cover;
wirelessly transmitting an audio input signal from the microphone to a microprocessor associated with the base based upon the received audio input;
operating the microprocessor to facilitate performance of a mobile telephone transmission based upon the audio input signal;
operating the microprocessor to process received incoming audio information at a transceiver of the base;
wirelessly transmitting an incoming audio information signal from the base to the speaker;
delivering an audio output through the speaker based upon the incoming audio information signal; and
returning the cover to the base to at least partially cover the display.

14. The method of claim 13, further comprising:
controlling computing operations of the microprocessor via input signals wirelessly transmitted from the microphone to the microprocessor while the cover is removed from the base.
